(19) United States
(12) Patent Application Publication
(10) Pub. No.: US 2015/0298718 A1
(43) Pub. Date: Oct. 22, 2015

(54) Sled Device

(71) Applicant: Steven Jodrell, Buxton Derbyshire (GB)

(72) Inventor: Steven Jodrell, Buxton Derbyshire (GB)

(21) Appl. No.: 14/684,386

(22) Filed: Apr. 12, 2015

(30) Foreign Application Priority Data
Apr. 18, 2014 (GB) 1407021.3
Nov. 14, 2014 (GB) 1420788.0

(51) Int. Cl. B62B 13/10; B62B 17/06

(52) U.S. Cl. CPC B62B 13/10; B62B 17/063; B62B 17/061

(57) ABSTRACT

A sled device comprises a seating platform body member, a left foot member, and a right foot member, a first side pivot member, and a second side pivot member, the seating platform, pivot ably connected to the foot members, via a semi-circular shaped pivot, a connecting element connecting the foot members, enabling steering ability, wherein the foot members are attachable into ski bindings, so that the sled device is usable on skis.

The present invention relates to, a standard pair of snow skis fitted to a steerable sled Device.

### BACKGROUND

Regular sleds, or sledges, only have fixed runners or a flat base and majority are not steerable.

Thus limited to, not able to interchange different runners for different snow conditions, limiting extra speed, manoeuvrability, distance can travel, able to dismantle easily, giving another use for, used, or redundant skis.

It would be desirable if a light weight portable sled device were provided, where by a user can easily interchange standard snow skis for different terrain and snow conditions.

DE3735477 1989 Meissner Andreas. No steering ability

U.S. Pat. No. 5,344,167 1994 Strouth John. No axle angle towing inward enabling the sled to steer, brakes system independent from skis, non-detachable from skis.

U.S. Pat. No. 6,969,074 B2 2005 Robert Piper. No axe angle towing inward enabling the sled to steer, no Rod cross member connection, (feet will move independently) will not detach from skis.

U.S. Pat. No. 5,000,466 1991 Den Hartog. Showing a seat suspended on the centre section steered by this method only.

U.S. Pat. No. 4,334,691 1982 Rudi Scheib. A double axle angle pivot, with no linking cross member, and none detachable skis.

U.S. Pat. No. 2,589,764 1952 Joseph Basso. No axle angle towing inward enabling the sled to steer, a split connecting Rod operated by an extra centre pivot directly connected to the feet, no means of ski brakes, no detachable skis.

### SUMMARY

The present invention seeks to provide a solution to these problem(s) by providing: a sled device, comprising: a seating platform; a left foot member and a right foot member; and a first side pivot member and a second side pivot member. All other feature(s)/element(s) in the present application are preferable and/or optional features. In one example embodiment, there is provided a sled device, comprising: a seating platform member; connected by means of at least one angled axle/pivot member, to at least one movable foot member, wherein a means of attaching a ski, and enabling steering ability, at least one support foot member, supports and protects against excessive over steer forces, there is provided at least one ski pole connection facility, another means of manual steering, the foot members are connected together by means of a movable collapsible, steerable, connecting Rod; thus facilitating manual steering, or brakes; of the device.

A portable lightweight sled device, suitable for sitting, lying down, and standing, to operate, comprising of a pair of movable foot member with fixings similar to a ski boot enabling a user to easily clip on a pair of standard snow skis, the foot members are connected to the seat member by an off-set angle axel pivot/member, enabling skis to bank at the correct angle enabling steering ability, also connected to each other by a movable collapsible cross member when collapsed inward enabling slowing down ability, moving the cross member from side to side enabling steering, wherein the foot members accommodate a pair of ski poles inserted by user enabling an additional means of manual steering.

Preferably ,there is provided a collapsible steering Rod as shown in the main description comprising of a centre joint and fitted with handles, wherein simpler to operate and least likely to malfunction than other collapsible rod methods.

Preferably, most aspects of the seat body member shape are functional, comprising of the curved to body , concaved shape seat , the front support and recesses, handle slot, and rear support, all aiding the user in giving comfort and ease of control .

Preferably, there is provided a low centre axle pivot to the base of the foot member, improves manoeuvring stability especially on soft snow conditions, this can be achieved by the standard axel shaft this also can be greatly improved on by the cup and semi-circular shaped pivot member method, wherein the centre can be level with the base of the foot member, or lower.

Preferably there is provided a movable foot member, thus providing a facility to accommodate a ski pole, providing an alternative means a user may manual steer the sled.

The present invention will now be more particularly described, with reference to the Accompanying drawings, by way of example only and in no way limiting the scope of the Invention in which:

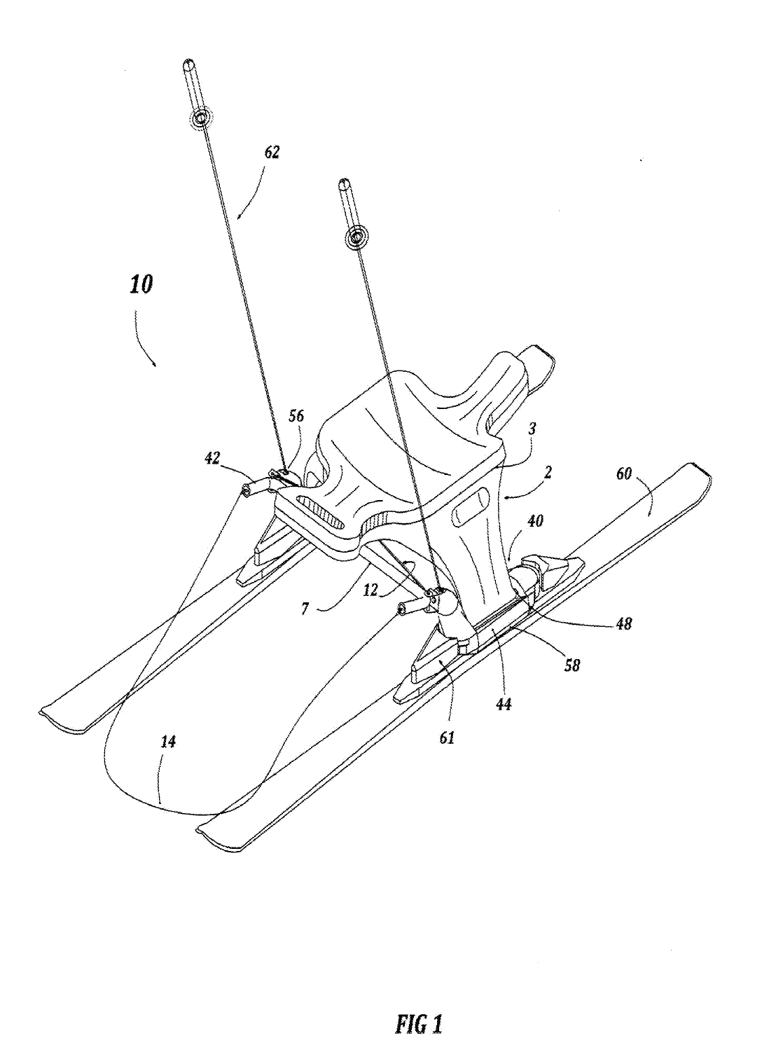

FIG. 1 a front side view of a full sled example, with all moving parts fitted to a sled device, including a fixed pair of snow skis, and ski poles;

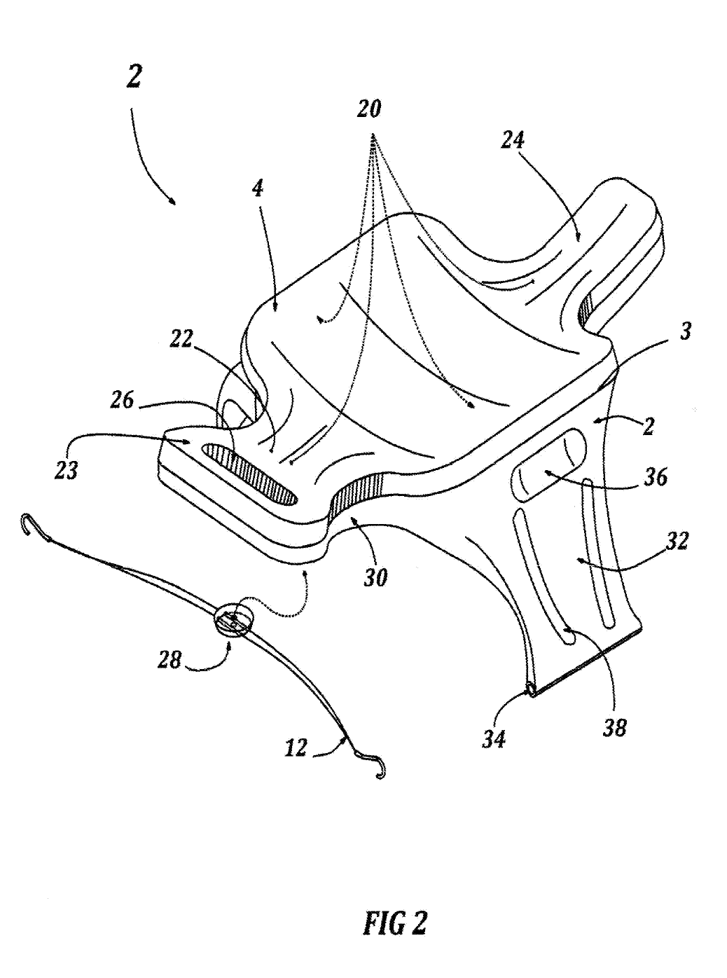

FIG. 2 a front side view of a sled seat body member with all moving parts removed, and a steering tensioning element ,

FIG. 3 a front side view of a detached movable foot member, with particular reference to a collapsible steering Rod, and detached ski stops.

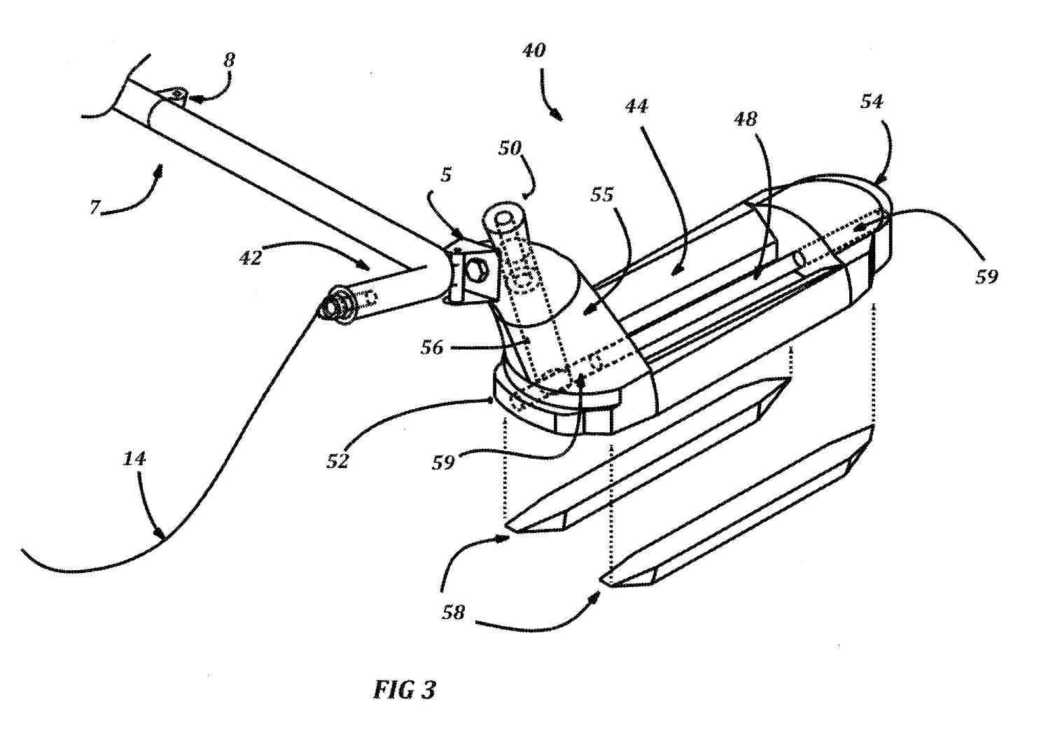

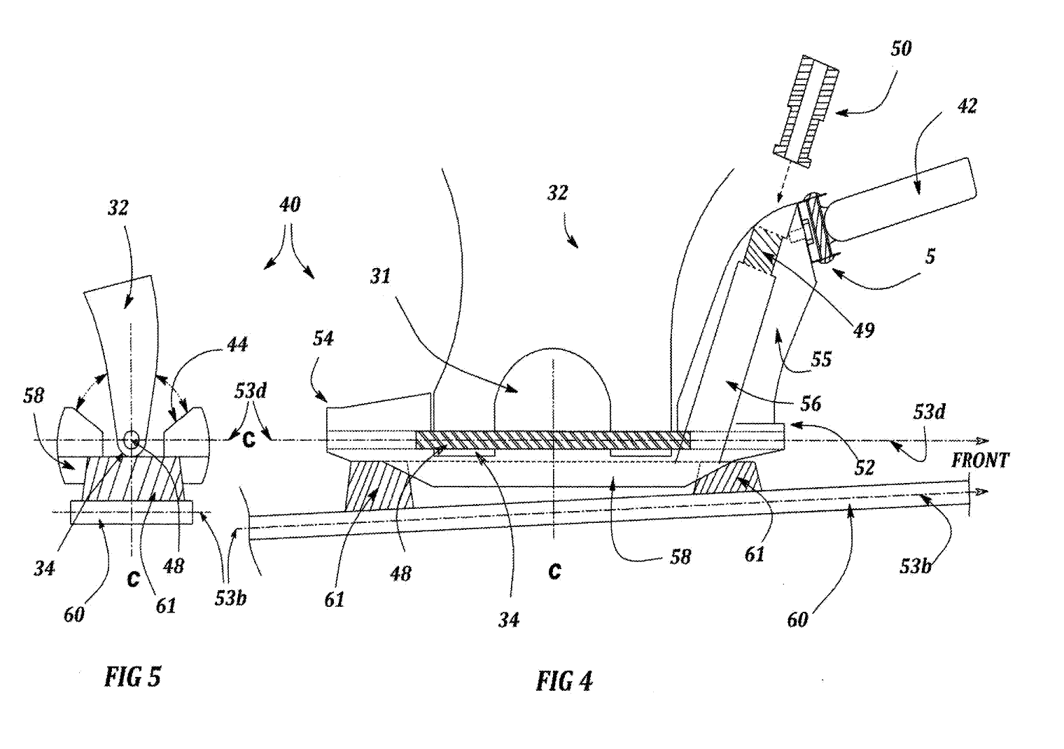

FIG. 4 a cutaway side view of a leg member connected to a movable foot member, in turn connected to a ski, with particular reference to the centre of the connecting axle angle in relation to the centre of the ski member, including a detailed view of a ski pole insert element.

FIG. 5 a cutaway section of the centre as in FIG. 4 with particular reference to the foot member supports or/over steer stops in relation to the leg member.

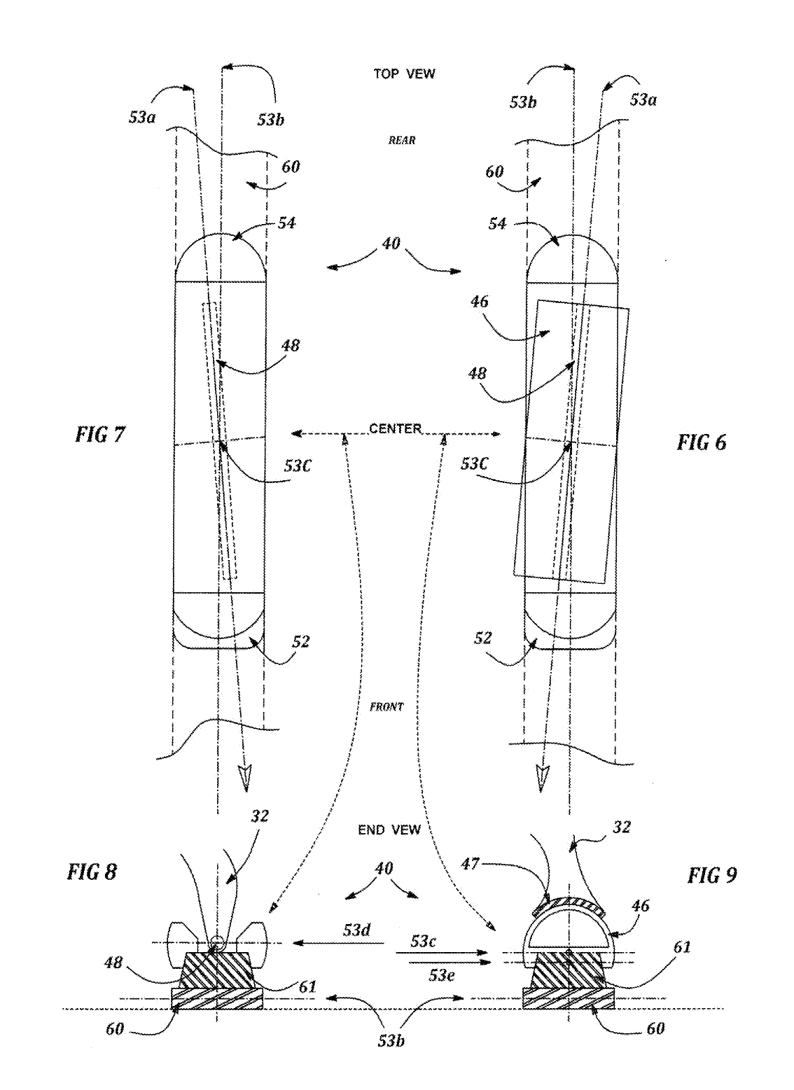

FIG. 6 a top diagram view of a preferred semi-circular shaped pivot foot member, with particular reference to the centre angle in relation to the centre of the ski.

FIG. 7 a top diagram view of an axle in a foot member, with particular reference to the centre angle in relation to the centre of the ski.

FIG. 8 the centre cutaway view as in FIG. 7 with particular reference to the axle centre height in relation to the base of the foot member.

FIG. 9 the centre cutaway view as in FIG. 6 with particular reference to the possible lower centre than in FIG. 8 of the semi-circular shaped pivot foot member, in relation to the centre of the ski member

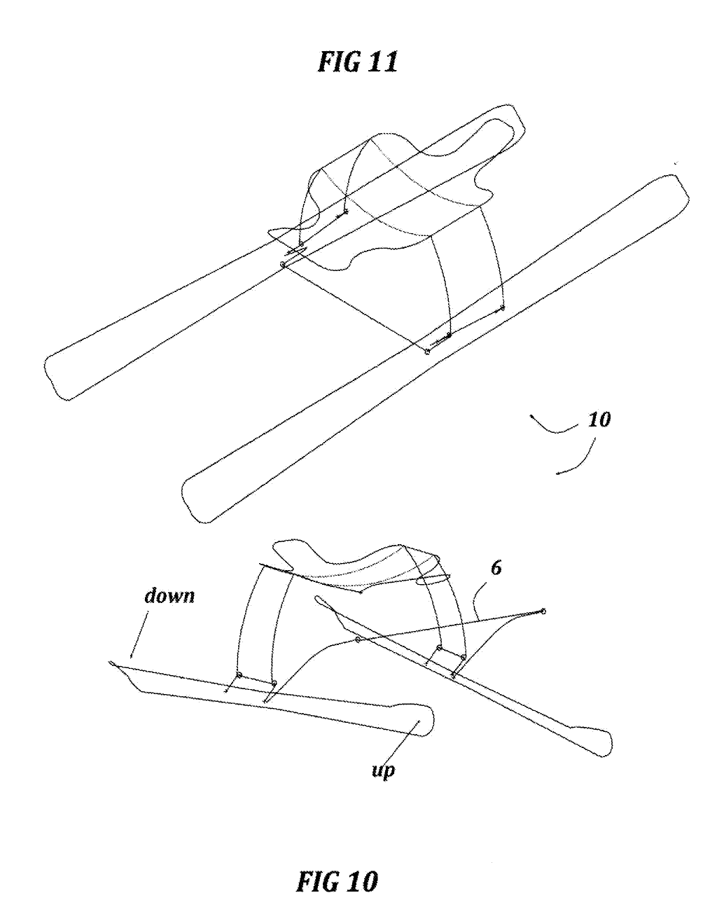

FIG. 10 the side view of a wireframe outline of a sled device attached to skis, with particular reference to an extreme left-hand steering position, with a clear view of the different ski banking angle positions.

FIG. 11 the wireframe front top left side view of the slide device attached to skis, as shown in FIG. 10

FIG. 12 a wireframe front left side view of the sled device attached to skis, with particular reference to a straight steer position , comprising of handles and a solid steering Rod;

FIG. 13 a wireframe front left side view of the sled device attached to skis, showing an extreme left-hand steering position, comprising of handles and a solid steering Rod ;

FIG. 14 a wireframe front left side view of the sled device attached to skis, with particular reference to a brakes position, comprising of a collapsible steering Rod;

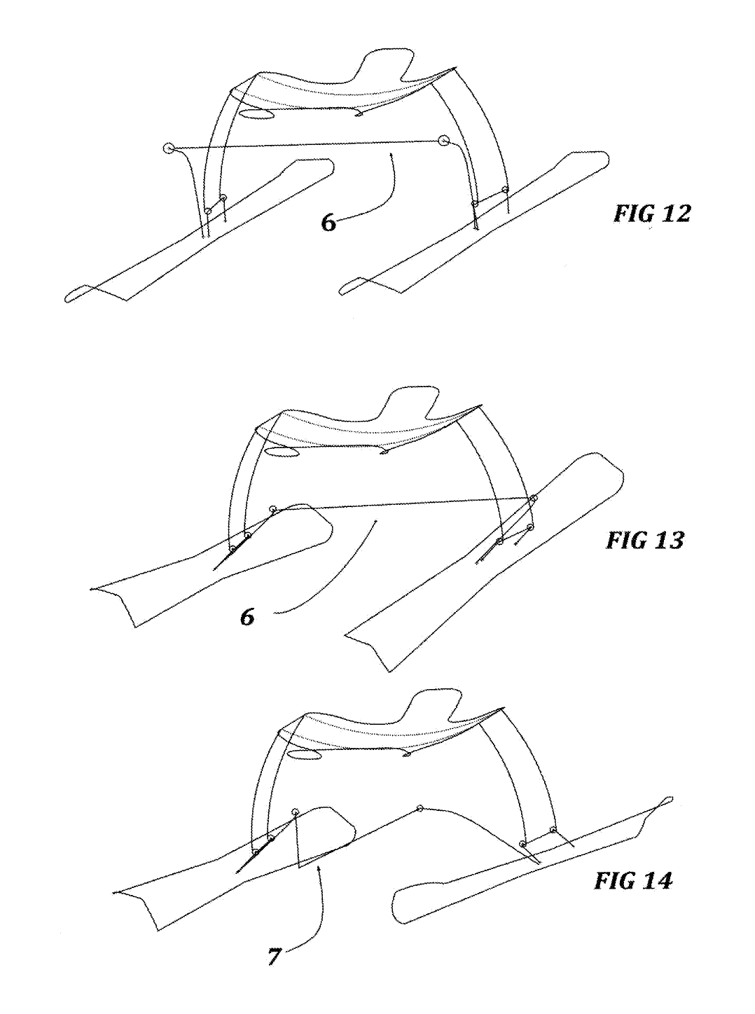

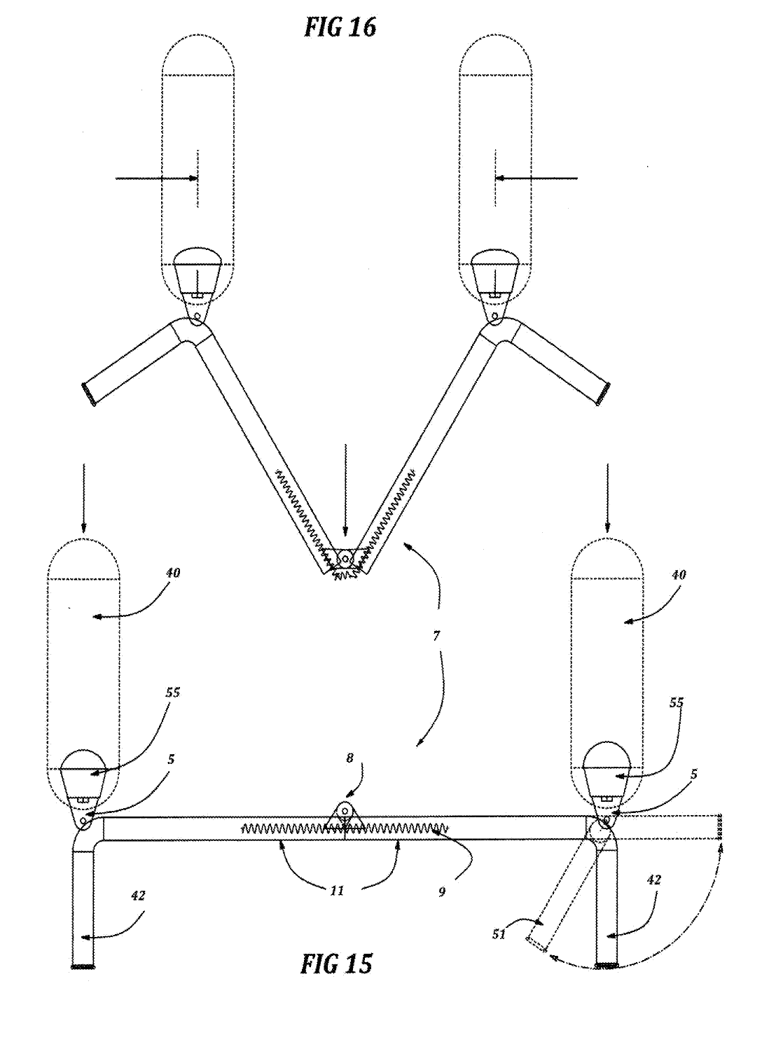

FIG. 15 a top detailed view of a collapsible steering Rod, there shown in a steering only; and in a non-brakes; position.

FIG. 16 a top view of a collapsible steering Rod as in FIG. 15 in a collapsed inward brakes position;

FIG. 17 a front side view of a detached foot movable member, as in FIG. 3 with particular reference to an optional connected steering handle, and a non-collapsible solid steering Rod;

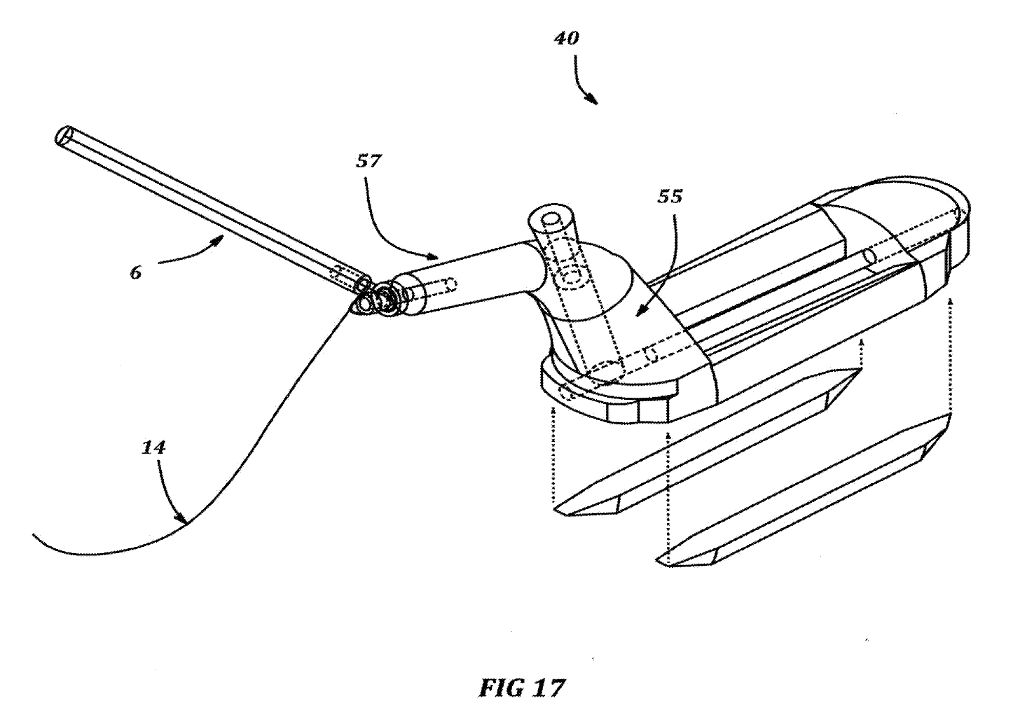

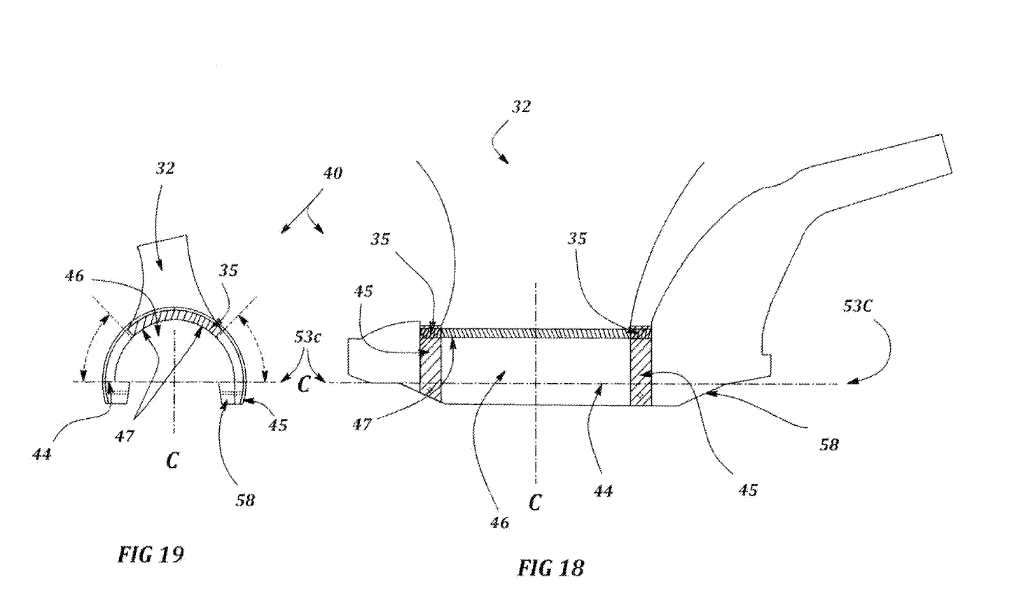

FIG. 18 a cutaway side view of body leg and foot member showing a preferred optional semi-circular shaped pivot member foot support, extended slot member support band, ski stop and handle;

FIG. 19 a cutaway's end section of the centre of the body leg cup support and foot member, as FIG. 18 extended slot member, ski stops, support band, foot semi-circular shaped pivot member support;

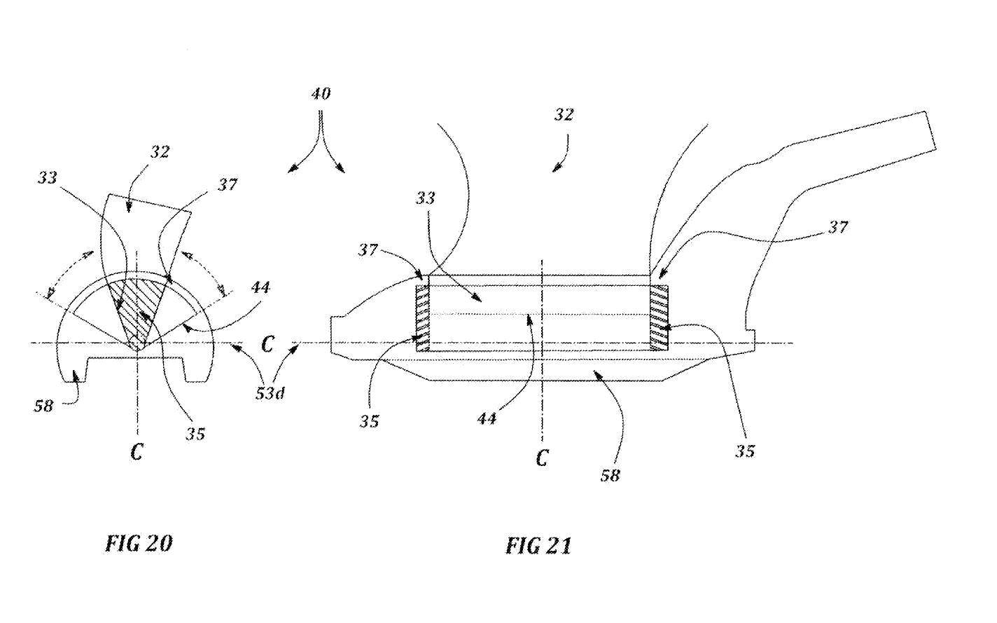

FIG. 20 the end centre cutaway section of an alternative way to pivot the body leg by way of a V shape leg end onto foot member V support;

FIG. 21 a cutaway side view of a V shaped leg, as FIG. 20 and foot member, showing the extended slot members with supports, and the handle.

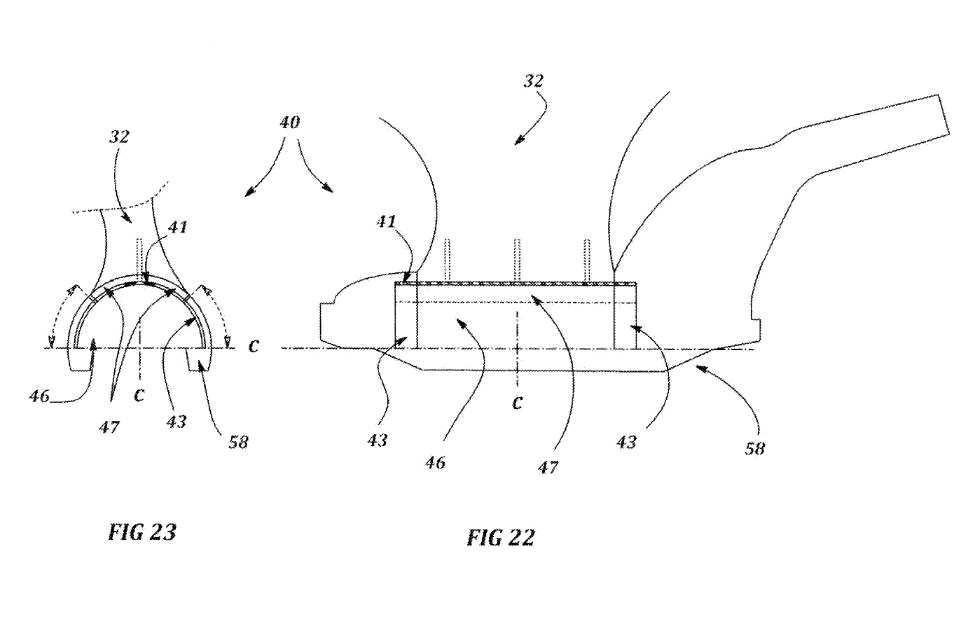

FIG. 22 a cutaway side view of the body leg, and foot member, showing the semi-circular shaped pivot member support, with particular reference to the slide bar, and slide bar recess.

FIG. 23 a cutaway end section of the centre of the body leg and foot member, showing the semi-circular shaped pivot member support, as FIG. 22 slide bar recess, slide bar, end view of the leg cup support;

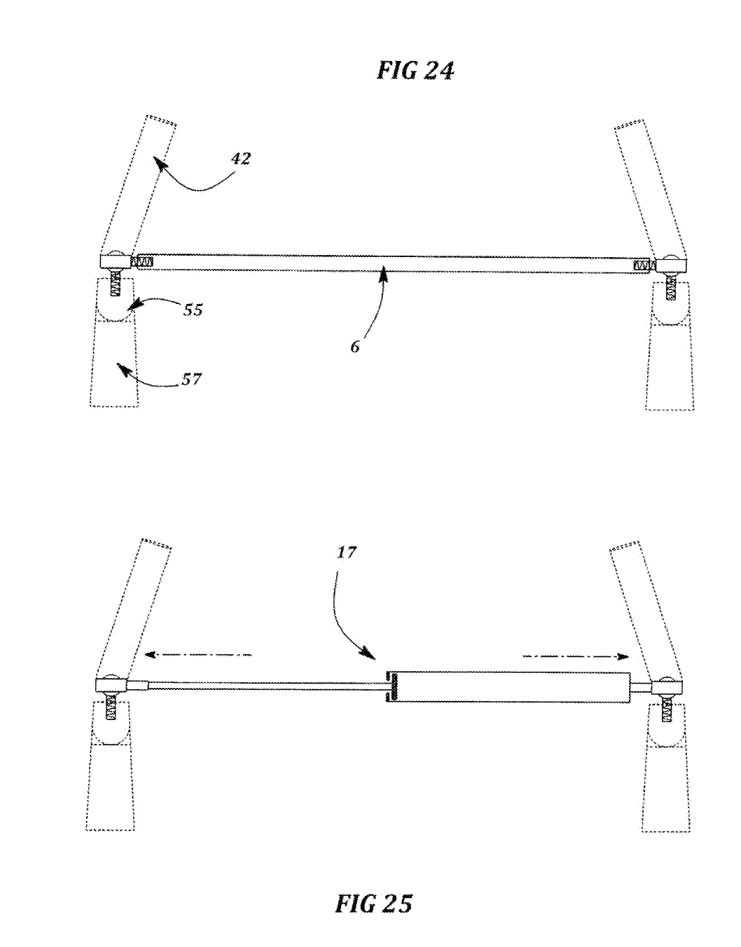

FIG. 24 an optional example of a solid steering Rod connected to a combination of handle connection possibilities showing an outline view of an upright member.

FIG. 25 an optional example of a collapsible steering rod and cylinder configuration connected to a combination of handle and support members.

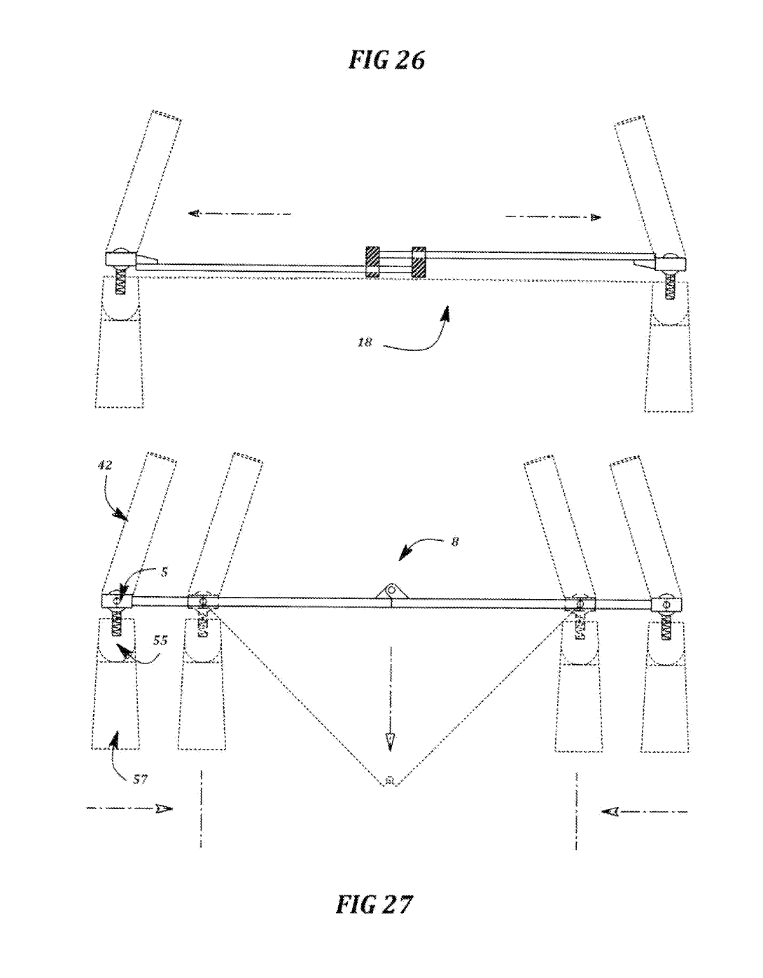

FIG. 26 optional example of a collapsible steering Rod configuration comprising of a pair of connecting Rod's one adjacent to the other;

FIG. 27 a collapsible steering Rod with particular reference to an offset forward facing centre joint enabling a backward collapsible position, a combination of handles and connection possibilities.

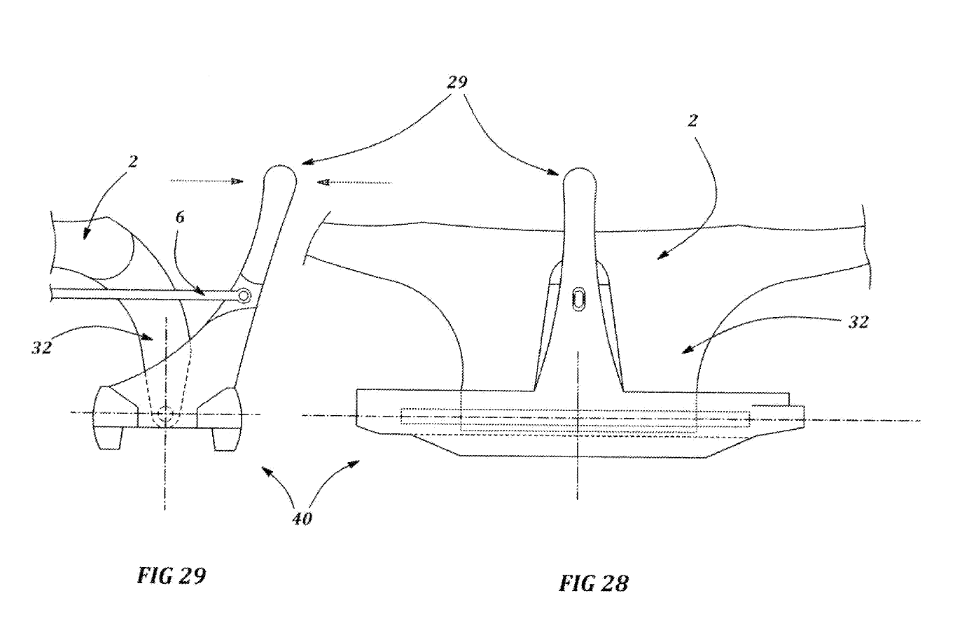

FIG. 28 a side view of the sled main body member showing an optional central positioned steering handle.

FIG. 29 a cutaway end view of the FIG. 28 showing the end cut away view of an optional central steering handle.

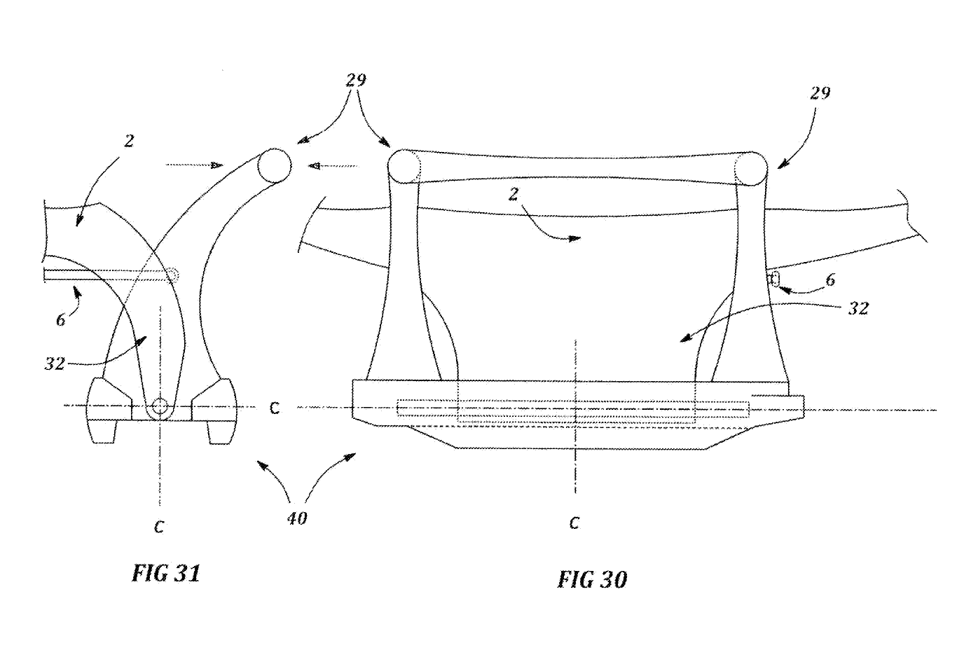

FIG. 30 a side view of the sled main body showing an optional double steering handle with support member.

FIG. 31 a cutaway end view of the main body leg as in FIG. 30, showing the end cut away view of one of the optional double steering handles.

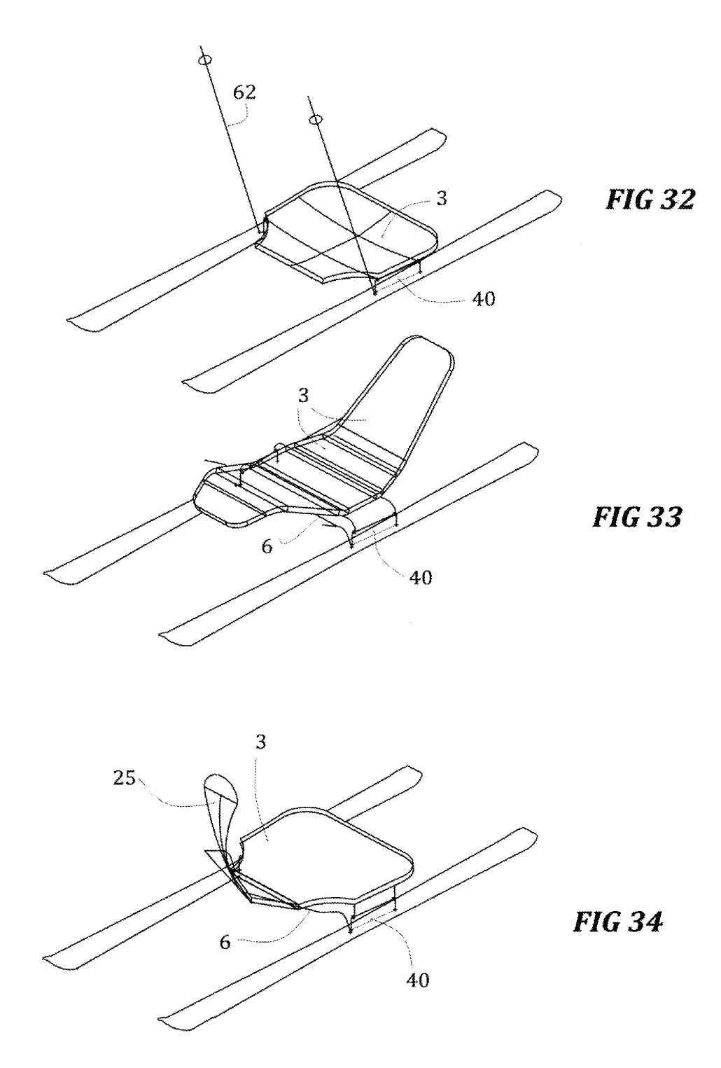

FIG. 32 a wireframe top left side view diagram of an optional stand on sled wherein the ski poles are the main means of steering

FIG. 33 a wireframe top left side view diagram of an optional lay-back lowdown seat type sled.

FIG. 34 a wireframe top left side view diagram of an optional stand on low sled steered by an upright central handle.

### DETAIL DESCRIPTION

Referring to the drawings, there is provided a sled device 10, comprising: a seating platform 3; a left foot member 40, and a right foot member 40; and a first side pivot member 46, and a second side pivot member 46.

The seating platform 3 is preferably pivot ably connected/connectable to the foot members 40 via the pivot members 46. The foot members 40 are attachable into ski bindings so that the sled device 10 is usable on skis.

Preferably the sled device 10 comprises a slide/pivoting system, wherein more preferably each pivot member 46 comprises a semi-circular shaped pivot member.

Preferably the device 10 further comprises a curved slide facilitation element 47 (which is preferably a cup support 47) in communication/engaged slid ably with the semi-circular shaped pivot member 46 to facilitate pivoting of the foot member 40 relative to the seating platform 2.

Preferably the sled device 10 comprises a connecting element 6 (which connecting element 6 is preferably a rod, but may be any other connecting element) connecting the foot members 40. In a preferred embodiment the connecting element 6 is collapsible.

Preferably the foot members 40 each comprise at least one ski stop member 58 to aid prevention of separation between ski binding and foot member 40. Preferably the ski stop member is located on an underside of the foot member.

Preferably the device comprises a forward facing support member 22. Preferably the forward facing support member 22 comprises an aperture 26, the forward facing support member 22 thus forming a handle.

Preferably the forward facing support member 22 is recessed 30 on both sides, thus facilitating manual steering access.

Preferably a body member 2 of the device comprises at least one strengthening support 38 to increase structural strength.

Preferably the seating platform/sled device comprises a narrowed rear protruding member 24.

In one example embodiment, there is shown a sled device 10, comprising a seating 3 platform body 2 member connected by at least one leg end 34 member, by means of at least one angled axle 48/pivot member, to at least one movable foot 40 member, wherein a means of attaching a ski, and enabling manual steering ability, at least one support 44 foot member; supports and protects against excessive over steer forces, there is provided at least one ski pole connection 56 facility; another means of manual steering, the foot members are connected together by means of a movable collapsible, steerable, connecting Rod 7 thus facilitating manual steering; or brakes; of the device.

There is shown in FIG. 2 a seat 3 platform body 2 member thus comprising of monocoque construction optional and/or internal light weight foam type filler, thus giving extra strength and rigidity. At least one strengthening support 38 formed of the structural skin body 2 moulding comprising of raised and or lower areas following the body 2 shape, giving extra strength and support for a given body shape. At least one manual grip support 36 formed as part of the structural skin body comprising of raised and/or lower areas located on the body member thus giving a user extra grip when adjusting the Sled 10 shown in FIG. 1 into a movable position. A concave 20 shaped seat 3 surface. Comprising of a low centre extending outward and/or upward in a front, rear, sideways, direction giving the user extra forward and sideways support.

There is shown in a forward facing support member 22 supports a manual gripping aperture facility 26, a widened area 23, located at the front of the support member 22, allowing support for the users legs when in a seating position , there is provided at least one recess 30 thus facilitating manual steering access located at the base of the neck of the forward facing support member 22, giving the user greater access to the steering handles 42 example shown in FIG. 1. A narrowed protruding seat extension 24 members located at the rear of the seat 3 platform wherein the user may grip onto with inner thighs when in a laying forward position.

There is shown in FIG. 2 seating element 4 forms to the seat 3 surface shape. Comprising of a foam or sponge material shaped to the seating 3 and extended seat members 22 and 24 wherein providing a user a softer body contact area, and absorbing shocks and vibrations transmitted through the body member 2.

There is shown in FIG. 7 and FIG. 8 a top view of both axle 48 pivot member front centres 53a, are closer than the centres 53a of the rear axle 48 pivot member.

There is shown in FIG. 4 at least one axle 48 pivot member front centre 53b, is closer to the centre 53b of the ski 60, than the rear of the axle 48 centre 53d pivot member. A combination of both examples there shown in FIG. 7 and in FIG. 4 enables the front of the outer ski to lift shown in FIG. 10, compared to the inner ski when a user steers the sled.

To achieve maximum foot member movable stability, it is important to achieve the lowest centre of the axle pivot as mechanically possible, example shown in FIG. 8 wherein the centre 53d of the axle 48 is near to the base of foot member 40 and centre 53b of the ski 60, a preferred example shown in FIG. 9 wherein a semi-circular shaped pivot member 46, and cup support 47 enables a lower centre 53c and/or 53e compared to an axle 48. Thus shown in FIG. 8.

There is shown in FIG. 20 and FIG. 21 an optional low centre 53d configuration, comprising of a V shaped leg 32 end 33 connected to a V shaped at the least one movable foot member 40 wherein accommodates at the least one foot support 44 member.

There is shown in FIG. 18 and FIG. 19 an optional pivot support connection between the leg 32 member, and the movable foot 40 member, comprising of at the least one support band 45 thus suitable for the body leg cup 47 support extended slot 35 member and semi-circular shaped pivot member 46, foot member 40, also suitable for other connection configurations including the V shape leg 32 and foot member their shown in FIG. 20 and FIG. 21.

There is shown in FIG. 20 and FIG. 21 an optional pivot support connection between the leg member, and the movable foot 40 member, comprising of a foot 40 and/or leg end 33, an extended 35 member, entering into a slot/recess 37 member.

There is shown in FIG. 22 and FIG. 23 an optional foot 40 to leg 32 pivot connection between at least one leg member 32 and at least one foot member 40 connection held by an optional extension slide bar 41 and slot recess 43 supported by the foot 40 member, this may be more suitable for the semi-circular shaped pivot member 46, foot member 40, and cup support 47.

There is shown in FIG. 18-19-20-21-22-23 at least one ski release stop 58 assisting in prevention of premature release of the ski member.

There is shown in FIG. 3 a foot member 40 thus comprising of a monocoque construction an optional and/or an internal light weight foam type filler thus giving extra strength and rigidity. A longitudinal foot support member 44 an up-right member 55 At least one shaft entry hole 59 aperture into the toe 52 and heel 54 members to accommodate an axle pivot shaft 48 member. There is shown detached from the foot 40 member at the least one ski stop 58 member, a toe 52 and heel 54, similar to a ski boot enabling user to connect to a standard ski bindings 61, There is shown in FIG. 1

There is shown in FIG. 4 and FIG. 5 at the least one protruding member 58 wherein the majority of embodiment is below the centre pivot line 53d of the foot member 40, wherein thus providing a means of assistance in stopping the premature release from the ski bindings 61 when under excessive forces.

There is shown in FIG. 17 at the least one optional fixed handle grip 57 connected to an upright member 55 connected to at the least one movable foot member 40, and showing an optional solid non collapsible connected steering Rod 6, and tow rope 14.

There is shown in FIG. 5 a centre end view of longitudinal support member 44 wherein the majority of embodiment is above the centre 53d pivot line, greatly strengthening the movable foot member 40 thus acting as a and/or over steer stop 44 at its maximum movable extent resting/stopping on the seat extended leg 32 axle housing thus preventing damage from excessive over steer forces.

There is shown in FIG. 1 a ski pole 62 inserted into the foot movable member 40 examples shown in FIG. 4 a flexible element 50 inserted into a recess aperture 49 extending into the main recess aperture 56 supported by the upright member 55 extending upward from the movable foot member 40.

There is shown in the FIG. 15 a collapsible movable cross member 7 comprising at the least one support Rod 11, the outline of the movable foot members 40 supporting a upright member 55 thus supported on the front and/or top face, of at the least one movable joint member 5, at least one connecting Rod 11 offset Centre joint 8, wherein enabling lock-up in position, a tension spring 9 assisting the Rod to spring back into place, when a user applying rod end forces, by pushing at least one manual handle grip 42 from side to side for normal steering use, example shown in FIG. 10 and FIG. 11 and FIG. 13 wherein pushing handles in an outward direction enabling the foot members 40 to collapse inward for slowing, example of rod 7 collapsed position shown in FIG. 16, example of skis in a slowing down position their shown in FIG. 14.

There is provided at least one manual handle grip 42 for holding, extending outward and/or in a preferred position 51. There is shown in the FIG. 3 and FIG. 4 an alternative view of a collapsible movable cross member 7 gripping handle 42 centre joint pivots 8 and movable coupling 5.

There is shown in FIG. 24 an optional example of a solid steering Rod 6 connected to a combination of connection possibilities showing an outline view of an upright member 55 and/or a solid steering handle 57 an optional manual handle grip 42.

There is shown in FIG. 25 an optional example of a collapsible steering Rod 17 a Rod and cylinder configuration connected to a combination of handle and support member's example shown in FIG. 24.

There is shown in FIG. 26 an optional example of a collapsible steering Rod 18 comprising of a pair of connecting Rod's one adjacent to the other fixed to slide bearings connected to an optional combination of a handle and support members example shown in FIG. 24.

There is shown in FIG. 27 a collapsible steering Rod as shown in FIG. 15 comprising of a offset centre joint 8 in an optional forward facing position thus enabling the Rod's to collapse inward (alternative to outward) into a brakes position their shown in FIG. 14, a combination of connection possibilities showing the outline view of a upright member 55 and/or a solid steering handle 57 an optional manual handle grip 42 and an alternative movable coupling 5 member.

There is shown in FIG. 1 a tensioning element 12 comprising of an end fixture to the foot members 40, and their shown in FIG. 2 a centre anchor 28 showing the position of fixing to the front seat extension 22, wherein assisting the user to centralise the steering handles 42 when extended fully outward as in FIG. 10

There is shown in FIG. 1 a flexible element comprising of a cord or a rope 14 connected to the steering handles 42 and/or seat front member 22 in FIG. 2 enabling a user to tow the sled manually.

There is shown in FIG. 4 a centre cutaway side view of a leg member 32 showing an optional recess aperture 31

There are a few steering handle optional configurations an example shown in FIG. 28 an alternative steering handle 29 layout side view of the sled main body member 2 comprising of a main body leg 32 connected to a movable foot member 40 showing a side view of an optional central positioned steering handle 29.

There is shown in FIG. 29 a cutaway end view of the FIG. 28, comprising of a sled main body member 2 connected to a movable foot member 40 by means of the leg member 32 thus showing the end cut away view of an optional central steering handle connected to a at the least one movable foot member 40, wherein a single movable connecting Rod 6 connects to the opposite foot member 40 (not shown) a handle 29 enabling simultaneously movement of the movable foot members 40 enabling steering ability.

Another optional example shown in FIG. 30 a side view of the sled main body 2 comprising of a main body leg 32 connected to a movable foot member 40 showing a side view of an optional double end fitted steering handles 29.

There is shown in FIG. 31 an alternative steering layout cutaway end view of the leg in FIG. 30, comprising of a sled main body member 2 connected to a movable foot member thus showing the end cut away view of one of the optional double steering handles 29 connected to a at the least one movable foot member 40, by means of the leg member 32 wherein at least one movable connecting Rod 6 connects to the opposite foot member 40 (not shown) a handle 29 enabling simultaneously movement of the movable foot members 40 enabling steering ability.

There are other optional full sled configurations thus comprising of the same foot member mechanical layout there is shown in FIG. 32 a top left side view wireframe diagram of an optional sled device, comprising of a lower standing platform 3, a pair of standard movable foot members 40 to accommodate only ski poles 62 and not handles, a connecting Rod and mechanism (not shown) the same as a standard sled, wherein a user operates and steers the sled only using standard ski poles.

There is shown in FIG. 33 a top left side view wireframe diagram of an optional sled device, comprising of a lower larger lay back seat 3, a pair of standard movable foot members 40 with manual gripping handles, a connecting Rod 6, all mechanical parts the same as a standard sled, wherein a user operates the sled in a lay backwards in a forward facing position.

There is shown in FIG. 34 a top left side view wireframe diagram of an optional sled device, comprising of a lower standing platform 3, a pair of standard movable foot members 40 connecting together by a split connecting Rod 6 fixed to a central upright member 25 enabling steering ability, wherein a user operates the sled in a stood on position manually gripping the central member steering the sled device.

Preferably there may be alternative design ways to manufacture parts on the sled, e.g. the foot movable member, wherein all the variations of the pivot's have a forward facing tow in angle as in FIG. 6-7, the axle pivot as in FIG. 3-4-5-7-8 may be simpler to manufacture and stronger in use, but may not perform quite as well on certain types of snow conditions compared to the semi-circular shaped pivot member, and cup support method as in FIG. 6-9-18-19, wherein as a lower centre in FIG. 9-53c to the foot base is preferable.

There is an alternative to the standard collapsible steering Rod 7 in FIG. 15 a solid steering Rod 6 as in FIG. 24 as with optional handles 42 fitted to a Rod 6 or solid handles 57 fitted to the foot upright members 55 as in FIG. 17 this optional method used gives equal steering performance compared to the collapsible Rod 7 in FIG. 15 without a slowing down capability as in FIG. 14.

Preferably a version of this standard sled device wherein the shape of the legs gives a means of suspension, example in the shape and the material of the legs absorbs some of the shocks and vibrations transmitted through the skis to the users body, the material used may be carbon fibre, or spring steel, or similar.

A version of this standard sled is to have foldaway legs enabling easier transportation and storage.

A alternative version of the sled device may be adapted for water recreation by means of being towed by a speedboat or jet ski, using the same mechanical layout as the snow sled, wherein the foot members need to be of bulkier design to accommodate water-skis, and the body shape larger to stay afloat when stationary, this sled device may be steered by the handles in a seating position or a rope, or handle attached to the feet for a standing position.

Manufacturing and materials used for this sled design, the preferred and one of the ways to manufacture the light weight hollow monocoque body and foot members, is rotationally moulded plastic, thus enabling extra strength in the body shell and moulded support ribs and perfect shaped to the mould giving a good detail finish.

There are other means to manufacture the sled, vacuum formed plastic, carbon fibre, blow moulding, tubular metal, preferably aluminium, these are not as adaptable, or too expensive and high tooling costs.

The invention will now be described in use, with reference to a preferred embodiment, in no way limiting a scope of the invention.

In use, there are many types of snow sleds or sledges, designed for recreational downhill use, a minority of them are steerable, also they perform only as good as the runners or base that is in contact with the snow, the ultimate type of runner, or runners, that has evolved over many years is the snow ski, with hundreds of variations, from long narrow skis, for highest speed and distance, and more recently a shorter wider stubbier ski, for ease of manoeuvrability in softer deeper snow, this steerable lightweight portable sled device, makes use of these perfect runners or skis, by enabling the user to easily transport the sled device to a snow, or dry ski slope destination, and easily clipping on a pair of snow skis to suit the site conditions.

The sled device is designed for one user in a lay down or seated position, or two users sat in a upright position, wherein the sled is fully steerable and has a slowing down capability, another way to steer the sled is to slot a pair of standard ski poles into the back of the steering handles, and by standing on the seat steering the sled.

The user can also tow the sled laden, or unlade, by means of a rope connected to the steering handles.

The sled may be manually transported on the users back by means of an optional straps or Harness, similar to a rucksack, with or without skis attached.

The embodiments described above are provided by way of example only, and various other modifications will be apparent to persons skilled in the art without departing from the scope of the invention as defined in the appended claims.

1. A sled device, comprising:
a seating platform;
a left foot member and a right foot member;
a first side pivot member, and a second side pivot member, the seating platform pivot ably connected to the foot members via the pivot members;
wherein the foot members are attachable into ski bindings so that the sled device is usable on skis.

2. A sled device as claimed in claim 1, wherein the foot members each pivot member comprise a semi-circular shaped pivot member.

3. A sled device as claimed in claim 2, wherein the device further comprises a curved slide facilitation element in communication slid ably with the semi- shaped pivot member circular to facilitate pivoting of the foot member relative to the seating platform.

4. A sled device as claimed in claim 1, wherein the sled device comprises a connecting element connecting the foot members.

5. A sled device as claimed in claim 4, wherein the connecting element is a rod.

6. A sled device as claimed in claim 4, wherein the connecting element is collapsible.

7. A sled device as claimed in claim 1, wherein the foot members each comprise a ski stop member to aid prevention of separation between ski binding and foot member.

8. A sled device as claimed in claim 7, wherein the ski stop member is located on an underside of the foot member.

9. A sled device as claimed in claim 1, wherein the seating platform comprises a forward facing support member.

10. A sled device as claimed in claim 9, wherein the forward facing support member comprises an aperture, the forward facing support member thus forming a handle.

11. A sled device as claimed in claim 9, wherein the forward facing support member is recessed on both sides, thus facilitating manual steering access.

12. A sled device as claimed in claim 1, wherein a body member of the device comprises at least one strengthening support to increase structural strength.

13. A sled device as claimed in claim 1, wherein the seating platform comprises a narrowed rear protruding member.
